(19) United States
(12) Patent Application Publication
(10) Pub. No.: US 2021/0269110 A1
(43) Pub. Date: Sep. 2, 2021

(54) Method and Apparatus for Replacement of Windshields for Recreational Vehicles, Charter Buses and Large Trucks

(71) Applicant: The WASP, LLC, Arvada, CO (US)

(72) Inventors: Kenneth R. Lockwood, Arvada, CO (US); Randall C. Lockwood, Arvada, CO (US); Kevin R. Lockwood, Arvada, CO (US)

(21) Appl. No.: 17/045,981

(22) PCT Filed: Apr. 11, 2019
(86) PCT No.: PCT/US2019/027081

§ 371 Date: Oct. 12, 2020

Related U.S. Application Data
(60) Provisional application No. 62/656,212, filed on Apr. 11, 2018.

(51) Int. Cl. B62D 65/06; B66C 1/02; B66F 7/06

(52) U.S. Cl. CPC B62D 65/06; B66C 1/0212; B66F 7/065; B66F 7/0625; B66C 1/0243

(57) ABSTRACT

Disclosed is a portable lift device that is capable of lifting one or more persons and a large windshield for installing a windshield in a recreational vehicle, charter bus or other large high-profile truck.

### FIELD OF ART

The disclosed device relates generally to a method and apparatus for removing and replacing a windshield, and more specifically to a portable device capable of lifting and suspending a windshield from motor homes, buses, heavy equipment, semi-trucks and other large vehicles and also reducing the manpower needed.

### BACKGROUND

A windshield is a key component of safety for a vehicle and its occupants. Windshields protect a vehicle's occupants from wind, rain, snow, rocks, debris, insects, dirt, dust, leaves, and other potential hazards. In addition, windshields protect occupants from being thrown from the vehicle. Further, windshields are integral to the structural integrity of the vehicle. Because a chip can affect the strength of the entire windshield, it is a priority that chipped windshields be timely replaced and by a technician who can ensure the job is done correctly.

Oftentimes it takes two technicians to replace a windshield in a common passenger vehicle. In addition, it usually takes two persons to carefully position the new glass within the frame and onto a new bead of urethane during the replacement stage.

Windshields on an RV or charter bus are often panoramic windshields, which makes them wider for increased visibility in the larger vehicles. Most panoramic windshields are one-piece as well. Because a typical RV windshield is one piece of glass that is about 110 inches wide and 60 inches tall, it can be very difficult to maneuver, especially if there is just one person. In fact, it usually takes at least four technicians to replace a panoramic windshield to ensure it is installed properly. This type of glass is large, heavy and oddly shaped which makes the windshield difficult to maneuver and easier to break.

The disclosed device provides a method and apparatus that is capable of lifting two people and a large windshield for installing into a recreational vehicle (or other large truck). In addition, the disclosed device can be used to lift and suspend a new windshield for installation into such a motor vehicle.

With the disclosed device, the prior two-person jobs can become one-person jobs. The four-person teams needed for RV windshield replacement can become two-person teams. In addition, the time it would take to perform the tasks involved can be shortened, thereby resulting in a higher removal/replacement efficiency and potentially greater financial gains and less breakage. Although the embodiments discussed herein pertain to the replacement of an RV windshield, the disclosed device can be adapted depending on the particular application to for example, trucks, vans, planes and other modes of transportation having a windshield.

### SUMMARY OF THE DISCLOSURE

The disclosed device provides for a windshield removal apparatus that can efficiently remove a windshield from a recreational vehicle.

The disclosed device provides for a windshield removal apparatus having casters making the device highly maneuverable, e.g., to a location in front of a recreational vehicle adjacent to the vehicle's windshield.

The disclosed device provides for a handheld remote control to control two powerful gear motors for moving the device away from the recreational vehicle/motorhome and from place to place.

The disclosed device provides for an upper platform to support and lift one or more technicians to a suitable height, e.g., up to about six feet, to perform work on a windshield.

The disclosed device provides for the use of a handheld remote control switch to energize a hydraulic pump and cylinder for actuating scissor beams which raise and lower an upper platform of the windshield removal apparatus.

The disclosed device provides for a windshield mounting assembly comprising an H-shaped frame that supports a set of four suction cups, the suctions cups being attachable to a windshield through the use of a handheld remote control switch which energizes a linear actuator to move toward and away from the windshield.

The disclosed device provides a vacuum pump for producing a vacuum which enables the attachment of the suction cups to the glass as the cups are pushed up against the glass.

The disclosed device provides a hand crank winch with a nylon strap that attaches to the H-shaped frame of the windshield mounting assembly to assist in lifting a windshield out of the windshield frame of a vehicle.

The disclosed device provides for a set of support arms extendable from the front of the upper platform to support the windshield mounting assembly with the windshield attached.

The disclosed device provides for a windshield mounting assembly that can pull a windshield back or away from a vehicle by reversing a linear actuator which moves a glide arm backwards.

These and other advantages of the disclosed device will appear from the following description and/or appended claims, reference being made to the accompanying drawings that form a part of this specification wherein like reference characters designate corresponding parts in the several views.

### BRIEF DESCRIPTION OF THE DRAWINGS

FIG. 1 is a front perspective view of disclosed device (assembly 1000) in a partially lowered position.

FIG. 2 shows a back perspective view.

FIG. 3 shows a bottom view.

FIG. 4 is an illustration of the disclosed device in a raised position.

FIG. 5 is a side view of the disclosed device in a raised position, the windshield mounting assembly shown positioned away from the front surface of the device.

Before explaining the disclosed embodiments of the disclosed device in detail, it is to be understood that the device is not limited in its application to the details of the particular arrangements shown, since the device is capable of other embodiments. Also, the terminology used herein is for the purpose of description and not of limitation.

### DESCRIPTION OF THE DISCLOSED EMBODIMENTS

The following description is provided to enable any person skilled in the art to make and use the disclosed apparatus. Various modifications, however, will remain readily apparent to those skilled in the art, since the generic principles of the present apparatus have been defined herein specifically to provide for a method and apparatus for facilitating a removal and replacement of a windshield.

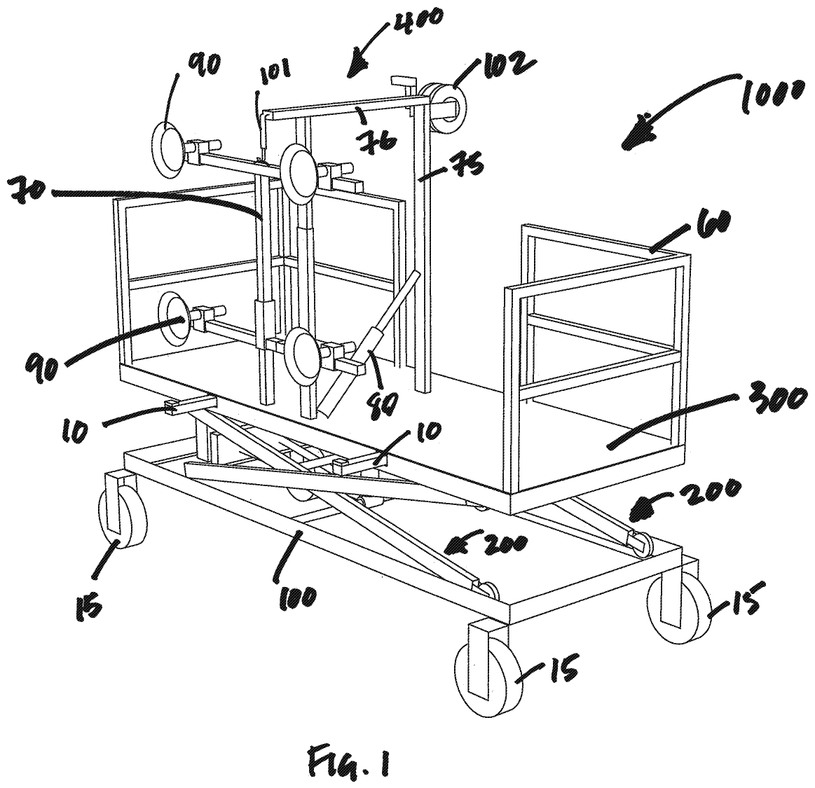

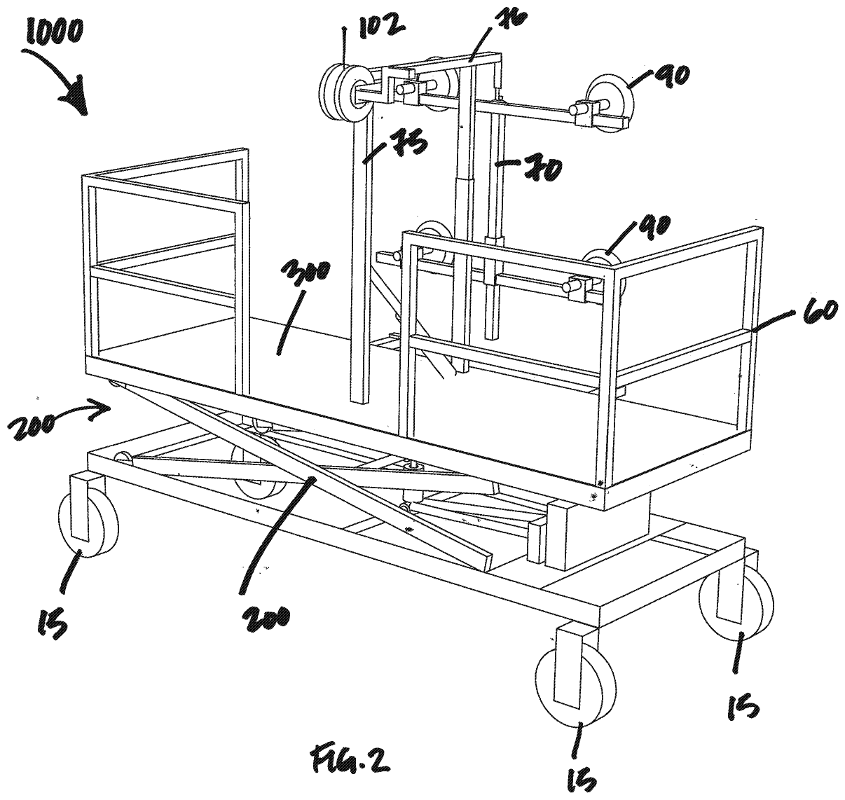

FIGS. 1, 2 show a front and back view of assembly 1000 in a lowered position. Assembly 1000 comprises a lower frame 100, a leg assembly 200 and a platform 300. In FIGS. 1, 2, leg assembly 200 is shown to be in a contracted, partially closed position.

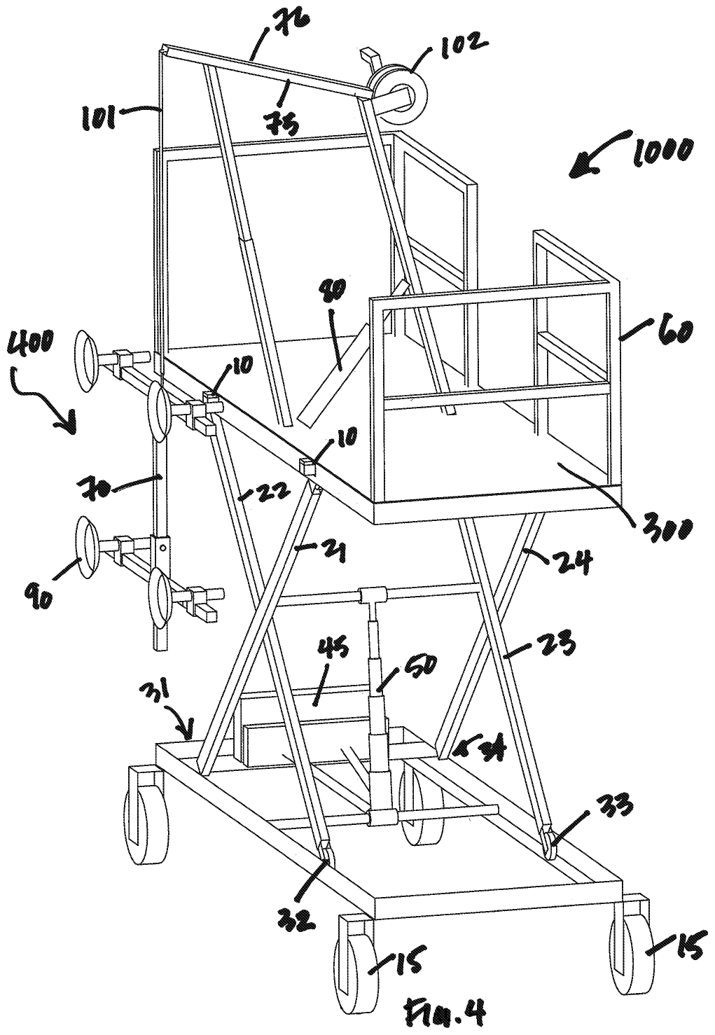

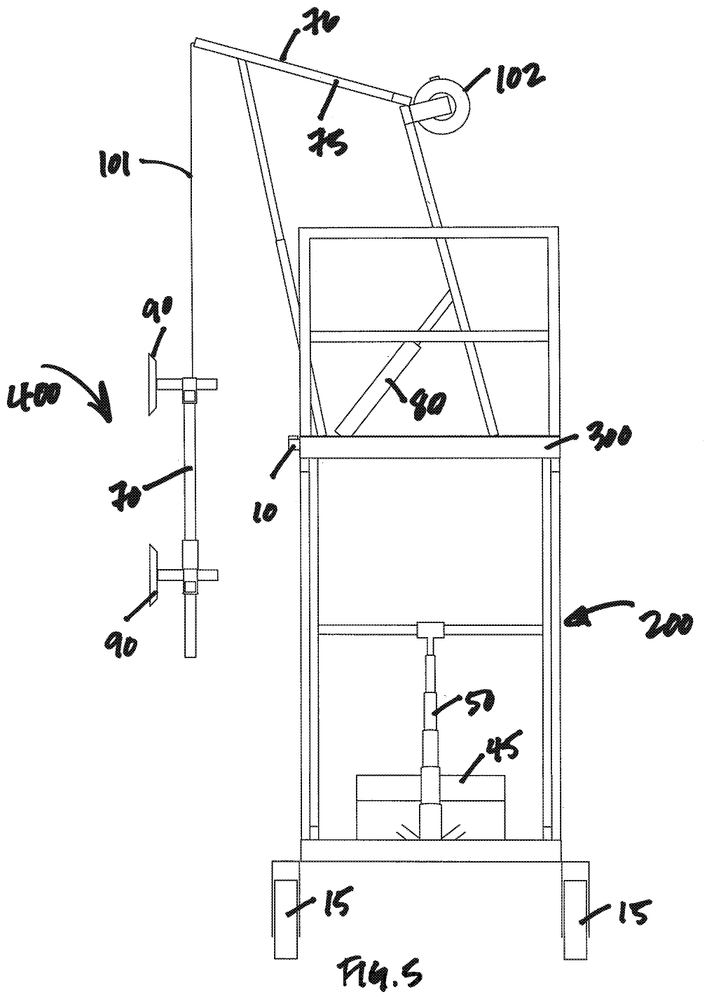

In FIGS. 4, 5, leg assembly 200 is shown to be in an expanded position; beams 21, 22, 23, 24 leg assembly 200 are extended and platform 300 is raised. A lower end of each of beams 21, 22, 23, 24 is connected to a roller 31, 32, 33, 34 which is configured to travel along an inside edge of frame 100. An upper end of each of beams 21, 22, 23, 24 is mounted to a bottom surface of platform 300. As shown, the lower ends of beams 21, 22, 23, 24 are connected to rollers 31, 32, 33, 34, respectively. Beams 21, 22, 23, 24 are configured to form a scissor beam.

Leg assembly 200 also comprises a hydraulic pump 45 with a cylinder 50 to help adjust the height of platform 300. A handheld remote control switch (not shown) energizes hydraulic pump 45 to cause the rod of cylinder 50 to move in an upward direction while an opposing pair of rollers (e.g., 31, 32 and 33, 34) moves inwardly toward each other guided along an inside edge of frame 100. An upper end of beams 21, 22, 23, 24 extends upwardly, raising platform 300 in a vertical direction to accommodate a desired vehicle height. In one embodiment, platform 300 can be raised six feet up off the ground. It is contemplated however that other platform heights could be suitable depending on the types of vehicle being serviced and the various assemblies of the disclosed device would be sized and engineered accordingly.

Safety rails 60 on platform 300 provide fall protection. Casters 15 provide maneuverability so that a technician would be able to move the device, for example, directly in front of a recreational vehicle or away from it.

Windshield mounting assembly 400 comprises various components: a glide arm 75, a linear actuator 80, a frame 70 having an H-shape, suction cups 90, a winch 102 and a nylon strap 101. Glide arm 75 and linear actuator 80 are mounted to a top surface of platform 300. Winch 102 comprises nylon strap 101 that runs atop horizontal member 76 of glide arm 75 and attaches to H-shaped frame 70 which can support a plurality of suction cups 90. In one embodiment, winch 102 comprises a hand crank, however winch 102 may be electrically controlled if desired.

A handheld remote control switch (not shown) is activated to energize linear actuator 80 which moves glide arm 75 toward or away from the windshield (not shown). During the windshield removal process, windshield mounting assembly 400 is maneuvered toward the windshield (not shown) so that suction cups 90 may be attached. Suction cups 90 are each connected by means of a vacuum hose (not shown) that is attached to a vacuum pump (not shown). After the vacuum pump is switched on, suction cups 90 of windshield mounting assembly 400 are pushed up against the windshield glass. The vacuum or suction created by the vacuum pump will secure suction cups 90 to the windshield glass. In one embodiment, a 120 V vacuum pump was utilized.

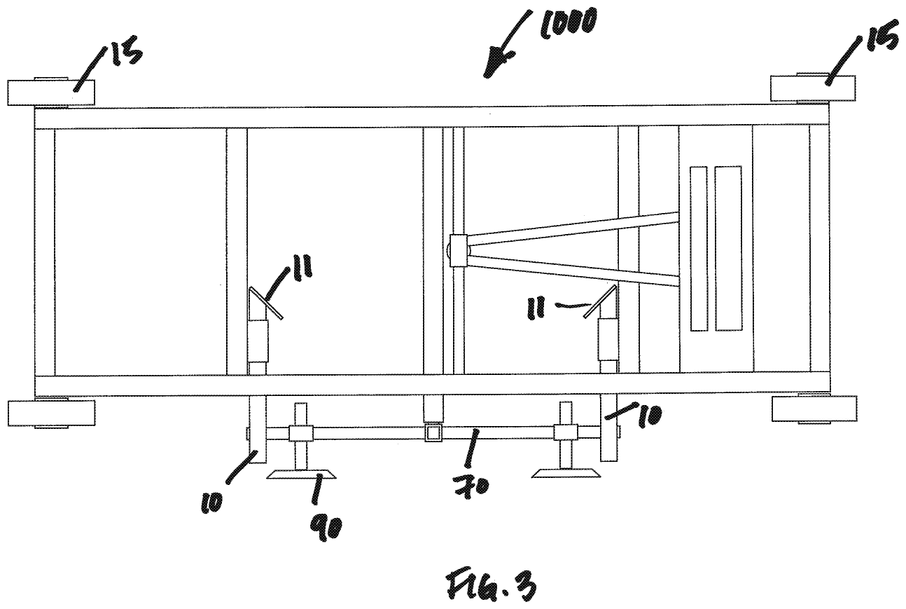

Winch 102 can be employed to lift the windshield out of the windshield frame (not shown) of the vehicle. By reversing linear actuator 80 so as to move glide arm 75 backwards, windshield mounting assembly 400 serves to pull the windshield back or away from the vehicle. If desired, windshield mounting assembly 400 and the windshield to which is attached can rest on support arms 10 that slide out from the front face of platform 300. Support arms 10 can slide in and out of housing slots in platform 300 and a prevented from moving past a limiter 11 as shown in FIG. 3

In operation, one or two technicians can stand on platform 300 and be lifted up to perform work on a large windshield of a recreational vehicle/motorhome. Technicians will then cut the urethane around the used or broken windshield to remove it. The next step is to position suction cups 90 of windshield mounting assembly 400 against the glass of the windshield to be removed by having linear actuator 80 guide glide arm 75 forward. Powering on the vacuum pump will create a vacuum to secure suction cups 90 to the windshield glass. Technicians can use winch 102 to lift the windshield out of the windshield frame. By reversing linear actuator 80 so as to move glide arm 75 backwards, windshield mounting assembly 400 serves to pull the windshield back or away from the vehicle. Using the handheld remote control, the entire assembly 1000 can be moved away from the recreational vehicle motorhome by means of two powerful gear motors (not shown). Platform 300 may then be lowered to the ground allowing the technicians to dismount and discard the old/broken windshield. Assembly 1000 can be used between the windshield removal and replacement stages to provide operator access to the vehicle's windshield frame in case it needs to be prepared to receive a new windshield.

After the windshield frame is prepared for the new windshield, technicians will be able to install the new windshield by reversing the steps mentioned above. For example, one or two technicians can stand on platform 300 with the new windshield and be lifted up to perform work on the recreational vehicle/motorhome. The new windshield is attached to the suction cup assembly (H-shaped frame 70 and suction cups 90) by turning on the vacuum pump and then pressing suction cups 90 to the glass. Technicians can use winch 102 to lift the windshield which can be set on support arms 10 protruding out of platform 300. In one embodiment, an H-shaped frame was utilized but it is contemplated that other frame configurations could be possible.

The handheld remote control of the disclosed device allows platform 300 to be lifted to a desired height. The handheld remote control of the disclosed device also allows the entire assembly 1000 to be moved closer to the recreational vehicle/motorhome for easier access to the working area. The handheld remote control of the disclosed device further allows for a windshield to be maneuvered up and down, as well as in and out, setting the windshield perfectly every time. Although the disclosed device is configured to operate using a handheld remote control device, it is contemplated that the disclosed device can be built with a voice activated controller that will control most functions by voice command. A 12 volt deep cycle battery was used in one embodiment of the disclosed device however alternative power sources could also be employed.

Disclosed is a windshield removal tool for large vehicles comprising: a leg assembly mounted on a base member, said leg assembly connected to a mechanical actuator providing a unidirectional force, said leg assembly being motivated in a vertical direction by said mechanical actuator to allow a platform connected to said leg assembly to vertically rise to accommodate a variety of vehicle heights; said platform capable of supporting and lifting one or more technicians to a suitable height to perform work on a windshield; a windshield mounting assembly mounted to said platform, said windshield mounting assembly comprising an H-shaped frame that supports a set of suction cups, the suction cups being attachable to a windshield through the use of a handheld remote control switch which energizes a linear actuator to move a glide arm attached to the windshield mounting assembly toward and away from the windshield; a vacuum pump for producing a vacuum to enable the securement of the suction cups to a windshield; a winch with a strap that attaches to the H-shaped frame of the windshield mounting assembly to assist in lifting a windshield out of a windshield frame of a vehicle; and wherein the windshield mounting assembly can pull a windshield back or away from a vehicle through the use of the handheld remote control switch which energizes the linear actuator to move the glide arm away from the windshield. The base member comprises casters. In addition, the apparatus further comprises a set of support arms extendable from a front surface of said platform to support the windshield mounting assembly with a windshield attached thereto. The handheld remote control switch activates at least one gear motor to move the apparatus from place to place. In addition, the handheld remote control switch energizes the mechanical actuator to motivate the leg assembly and the platform in a vertical direction.

Disclosed is a windshield mounting assembly, said apparatus comprising: a frame connected to a plurality of suction cups to form a suction cup assembly, the suction cups being attachable to a windshield through the use of a handheld remote control switch which energizes a linear actuator to move a glide arm attached to the suction cup assembly toward and away from the windshield; the glide arm and linear actuator mounted to a moveable platform capable of supporting and lifting one or more technicians to a suitable height to perform work on the windshield; a vacuum pump for producing a vacuum to enable the securement of the suction cups to the windshield; a winch with a strap that attaches to the suction cup assembly to assist in lifting the windshield out of a windshield frame of a vehicle; and wherein the suction cup assembly can pull a windshield back or away from a vehicle through the use of the handheld remote control switch which energizes the linear actuator to move the glide arm attached to the suction cup assembly away from the windshield. The handheld remote control switch energizes a hydraulic pump and cylinder for actuating scissor beams which raise and lower the moveable platform. The moveable platform comprises a set of support arms protruding from a front surface of said platform upon which the suction cup assembly with a windshield attached thereto can rest. In addition, the frame further comprises an H-shape.

Disclosed is a method for providing a windshield mounting assembly for removing and replacing a windshield from a large vehicle, said method comprising the steps of: providing a movable frame comprising a leg assembly connected to a mechanical actuator which motivates said leg assembly and a platform attached thereto in a vertical direction; providing a windshield mounting assembly mounted to said platform, said windshield mounting assembly comprising an H-shaped frame that supports a plurality of suction cups, the H-shaped frame connected to a winch on the glide arm by means of a strap to assist in lifting a windshield out of a windshield frame of a vehicle; enabling one or more technicians to access said platform and be lifted to a suitable height to perform work on a windshield; attaching the suction cups to a windshield through the use of a handheld remote control switch which energizes a linear actuator to move a glide arm attached to the windshield mounting assembly toward and away from the windshield; activating a vacuum pump to produce a vacuum to secure the suction cups to a windshield; employing the winch on the glide arm to lift the windshield out of a windshield frame of a vehicle; and pulling the windshield back or away from a vehicle through the use of the handheld remote control switch which energizes the linear actuator to move the glide arm away from the windshield. The method further comprises the step of lowering said platform and allowing for a replacement windshield to be lifted to a suitable height to perform work on a windshield. In addition, the method further comprises the step of activating a vacuum pump to produce a vacuum to secure the suction cups to a replacement windshield. The method further comprises the step of employing the winch on the glide arm to lift the windshield so it can be guided and set into the windshield frame. In addition, the method further comprises the step of using the handheld remote control switch which energizes the linear actuator to move the glide arm toward the windshield frame to insert the new windshield. Also, the method further comprises the step of accessing a set of support arms protruding from a front surface of said platform upon which windshield mounting assembly with a windshield attached thereto can rest.

The disclosed device and method have been described with reference to disclosed embodiments, however numerous modifications and variations can be made and still the result will come within the scope of the disclosure. No limitation with respect to the specific embodiments disclosed herein is intended or should be inferred.

1. A windshield removal tool for large vehicles comprising:
a leg assembly mounted on a base member, said leg assembly connected to a mechanical actuator providing a unidirectional force, said leg assembly being motivated in a vertical direction by said mechanical actuator to allow a platform connected to said leg assembly to vertically rise to accommodate a variety of vehicle heights;
said platform capable of supporting and lifting one or more technicians to a suitable height to perform work on a windshield;
a windshield mounting assembly mounted to said platform, said windshield mounting assembly comprising an H-shaped frame that supports a set of suction cups, the suction cups being attachable to a windshield through the use of a handheld remote control switch which energizes a linear actuator to move a glide arm attached to the windshield mounting assembly toward and away from the windshield;
a vacuum pump for producing a vacuum to enable the securement of the suction cups to a windshield;
a winch with a strap that attaches to the H-shaped frame of the windshield mounting assembly to assist in lifting a windshield out of a windshield frame of a vehicle; and
wherein the windshield mounting assembly can pull a windshield back or away from a vehicle through the use of the handheld remote control switch which energizes the linear actuator to move the glide arm away from the windshield.

2. The apparatus of claim 1, wherein said base member comprises casters.

3. The apparatus of claim 1 further comprising a set of support arms extendable from a front surface of said platform to support the windshield mounting assembly with a windshield attached thereto.

4. The apparatus of claim 1, wherein the handheld remote control switch activates at least one gear motor to move the apparatus from place to place.

5. The apparatus of claim 1, wherein the handheld remote control switch energizes the mechanical actuator to motivate the leg assembly and the platform in a vertical direction.

6. A windshield mounting assembly, said apparatus comprising:
a frame connected to a plurality of suction cups to form a suction cup assembly, the suction cups being attachable to a windshield through the use of a handheld remote control switch which energizes a linear actuator to move a glide arm attached to the suction cup assembly toward and away from the windshield;
the glide arm and linear actuator mounted to a moveable platform capable of supporting and lifting one or more technicians to a suitable height to perform work on the windshield;
a vacuum pump for producing a vacuum to enable the securement of the suction cups to the windshield;
a winch with a strap that attaches to the suction cup assembly to assist in lifting the windshield out of a windshield frame of a vehicle; and
wherein the suction cup assembly can pull a windshield back or away from a vehicle through the use of the handheld remote control switch which energizes the linear actuator to move the glide arm attached to the suction cup assembly away from the windshield.

7. The apparatus of claim 6, wherein the handheld remote control switch energizes a hydraulic pump and cylinder for actuating scissor beams which raise and lower the moveable platform.

8. The apparatus of claim 6, wherein the moveable platform comprises a set of support arms protruding from a front surface of said platform upon which the suction cup assembly with a windshield attached thereto can rest.

9. The apparatus of claim 6, wherein the frame further comprises an H-shape.

10. A method for providing a windshield mounting assembly for removing and replacing a windshield from a large vehicle, said method comprising the steps of:
providing a movable frame comprising a leg assembly connected to a mechanical actuator which motivates said leg assembly and a platform attached thereto in a vertical direction;
providing a windshield mounting assembly mounted to said platform, said windshield mounting assembly comprising an H-shaped frame that supports a plurality of suction cups, the H-shaped frame connected to a winch on the glide arm by means of a strap to assist in lifting a windshield out of a windshield frame of a vehicle;
enabling one or more technicians to access said platform and be lifted to a suitable height to perform work on a windshield;
attaching the suction cups to a windshield through the use of a handheld remote control switch which energizes a linear actuator to move a glide arm attached to the windshield mounting assembly toward and away from the windshield;
activating a vacuum pump to produce a vacuum to secure the suction cups to a windshield;
employing the winch on the glide arm to lift the windshield out of a windshield frame of a vehicle; and
pulling the windshield back or away from a vehicle through the use of the handheld remote control switch which energizes the linear actuator to move the glide arm away from the windshield.

11. The method of claim 10 further comprising the step of lowering said platform and allowing for a replacement windshield to be lifted to a suitable height to perform work on a windshield.

12. The method of claim 10 further comprising the step of activating a vacuum pump to produce a vacuum to secure the suction cups to a replacement windshield.

13. The method of claim 12 further comprising the step of employing the winch on the glide arm to lift the windshield so it can be guided and set into the windshield frame.

14. The method of claim 12 further comprising the step of using the handheld remote control switch which energizes the linear actuator to move the glide arm toward the windshield frame to insert the new windshield.

15. The method of claim 10 further comprising the step of accessing a set of support arms protruding from a front surface of said platform upon which windshield mounting assembly with a windshield attached thereto can rest.
